(19) United States
(12) Patent Application Publication
(10) Pub. No.: US 2007/0124573 A1
(43) Pub. Date: May 31, 2007

(54) Method for rapid startup of a computer system

(76) Inventors: Phillip M. Walker, Fort Collins, CO (US); Timothy G. Barry, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,132

(22) Filed: Oct. 28, 2005

(51) Int. Cl. G06F 9/00

(52) U.S. Cl. 713/2

(57) ABSTRACT

A method for rapid startup of a computer system. A hibernated image is accessed from an image library comprising a plurality of hibernated images, the hibernated image comprising information captured by an operating system when a running computer system is placed into a hibernated state wherein a hibernated computer system is operable to awaken from a hibernated state faster than booting a powered down computer system. The hibernated image is copied onto a boot disk of the computer system. The computer system is awakened from the hibernated state.

### TECHNICAL FIELD

Embodiments of the present invention relate to the field of computing resources. More specifically, embodiments of the present invention relate to a method for rapid startup of a computer system.

### BACKGROUND ART

Modern networking continues to provide an improvement in communication and information access using a utility computing environment. As an example, in-house data centers, associated with a particular entity of interrelated group of users, could contain a large number of information technology (IT) resources that are interconnected through a network. These networks are configured in different ways depending on implementation-specific details such as the hardware used and the physical location of the equipment, and depending on the particular objectives of the network. One common type of network configuration is a local area network (LAN). In actual practice, a typical LAN will include large numbers of computer systems and switches (as well as other devices). Another common type of network configuration is a storage area network (SAN). In actual practice, a typical SAN will include large numbers of disk logical units (LUNs) of a disk array and switches (as well as other devices). Devices such as computer systems, routers, switches, load balancers, firewalls, and the like, are commonly linked to each other in networks.

Generally, the in-house data centers include technicians working from a network operation center (NOC). The technicians issue commands to control the deployment of servers and to control the supporting infrastructures, such as disk logical units (LUNs) in a disk array, network switches in the LAN, and switches in the SAN.

A central feature of in-house data centers is the providing allocation of the servers on demand. Currently, this process involves booting a hardware server from an operating system image. An entire bootable image is copied to a provisioned server's boot volume and the server is rebooted from scratch. Server boot times vary, but typically take anywhere from several minutes up to an hour. Often, the boot times may appear to a client requesting the use of the server as a delay from the time of the service request prior to the service becoming available. For example, consider a web server that begins receiving a sudden increase in web traffic. In order to compensate for the increase in traffic, a second web server is requested for deployment. The additional web server is subject to standard boot times, delaying its actual deployment.

Therefore, a need exists for improving startup times of the deployment of information technology resources.

### DISCLOSURE OF THE INVENTION

Various embodiments of the present invention, a method for rapid startup of a computer system, are described herein. A hibernated image is accessed from an image library comprising a plurality of hibernated images, the hibernated image comprising information captured by an operating system when a running computer system is placed into a hibernated state wherein a hibernated computer system is operable to awaken from a hibernated state faster than booting a powered down computer system. The hibernated image is copied onto a boot disk of the computer system. The computer system is awakened from the hibernated state.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a rapid server deployment system, in accordance with embodiments of the present invention.

FIG. 2 is a block diagram of an exemplary software system including a rapid server deployment system, in accordance with embodiments of the present invention.

FIG. 3 is a block diagram of an exemplary farm, in accordance with embodiments of the present invention.

FIG. 4 is a block diagram of an exemplary utility data center, in accordance with embodiments of the present invention.

FIG. 5 is a flowchart of process for rapid deployment of a computer system, in accordance with an embodiment of the present invention.

The drawings referred to in this description should not be understood as being drawn to scale except if specifically noted.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. In other instances, well known methods, procedures, components, and circuits have not been described in detail as not to unnecessarily obscure aspects of the present invention.

Aspects of the present invention may be practiced on a computer system, also referred to herein as a provisionable resource or an information technology (IT) resource herein, that includes, in general, a processor for processing information and instructions, random access (volatile) memory (RAM) for storing information and instructions, read-only (non-volatile) memory (ROM) for storing static information and instructions, and a data storage device such as a magnetic or optical disk and disk drive for storing information and instructions. The computer system may also include an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

### SOFTWARE SYSTEM AND FUNCTIONAL OVERVIEWS

Embodiments of the present invention are directed to a method for rapid startup of a computer system. In one embodiment, the computer system is a provisionable resource (IT resource) of a utility computing environment. A hibernated image is copied onto he boot drive of the computer system. A hibernated image is a data file that includes information captured by an operating system when a running computer system is placed into a hibernated state or mode. By copying a hibernated image onto a computer system, the computer system may be awakened from the hibernated state without requiring a reboot of the computer system.

Current art only uses hibernated images to awaken a computer on which they were created. The present invention, in contrast, typically uses a hibernated image generated on one computer system to awaken another computer system. Only rarely and by coincidence might the computer system on which the hibernated image was created be awakened by it's own prior hibernated image.

A hibernation state allows for rapid resumption of operation of the computer system that is faster than rebooting the computer system. When the hibernation mode is activated, information describing the current status of the computer system is saved in a hibernation image. The hibernation image includes information describing the operation of the computer system, such as the operating system, the available memory, and the network connection status. The hibernation image may also include, for example, which applications are running on the computer system and which devices are connected to the computer system. Awakening a computer system from a hibernated state allows for rapid resumption of operation of the computer system.

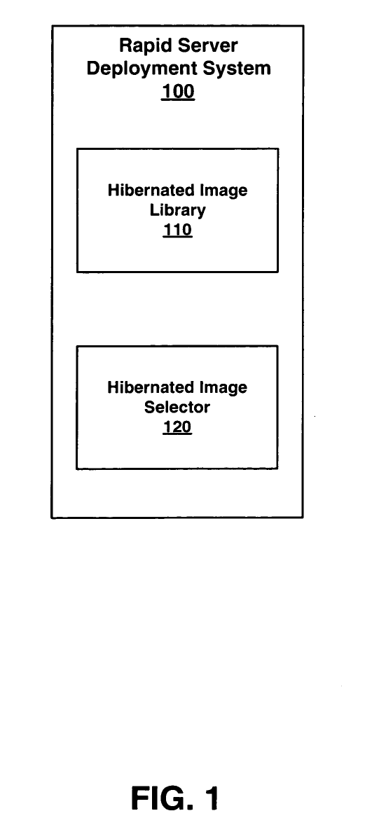

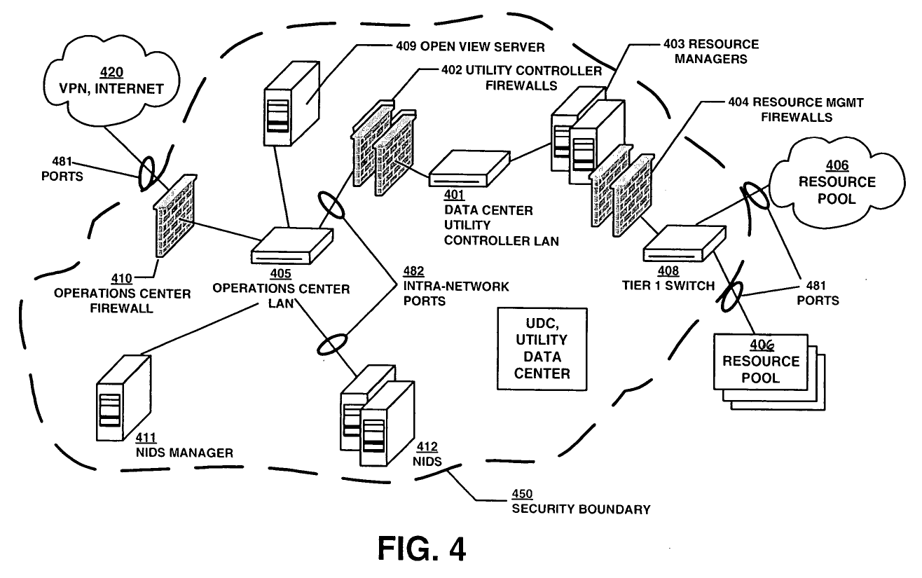

FIG. 1 is a block diagram of a rapid server deployment system, in accordance with embodiments of the present invention. The blocks in FIG. 1 can be arranged differently than as illustrated, and can implement additional or fewer features than what are described herein. Moreover, the blocks of FIG. 1 may be distributed across a utility data center (e.g., utility data center 400 of FIG. 4) or a network, such as a local area network (LAN). Further, the features represented by the blocks in FIG. 1 can be combined in various ways.

Rapid server deployment system 100 includes hibernated image library 110 and hibernated image selector 120. Hibernated image library 110 includes a plurality of hibernated images. The hibernated images include information captured when various types and configurations of computer systems with different specifications are placed in a hibernated state. For example, hibernated image library 110 may include hibernated images for computer systems using different processors, having different amounts of available memory (e.g. DRAM), different network connections, different operating systems, and different combinations thereof. It should be appreciated that many other types of configuration details may be included in a hibernated image, such as specific user configurations and installed software applications, and is not limited to the listed examples.

Most computer operating systems provide hibernated state functionality for placing a computer system into hibernation. It should be appreciated that the hibernated image for a particular operating system includes the information required to awaken a computer system with that operating system installed thereon. While different operating system may implement their respective hibernation states differently, a hibernated image of the present invention includes information necessary for the particular operating system for which the hibernated image was created.

The hibernated images of hibernated image library 110 may be created in many ways. In one embodiment, the hibernated images are based on a general computer system configuration. For example, the hibernated images may be based on processor type, memory availability, and operating system. A computer system is booted using a boot image using a standard start-up function. Once the computer system has started, the computer system is placed in a hibernated state using the hibernation function of the operating system. The hibernated image of the computer system is captured using standard image capture techniques that are well-known in the art. The hibernated image is copied into hibernated image library 110 for access by hibernated image selector 120.

Hibernated image selector 120 is operable to select a hibernated image from hibernated image library 110. In one embodiment, the hibernated image is selected in response to a deployment request received in accordance with a utility computing environment. A pool of servers in a utility computing environment are available for reallocation among clients. When a server is reallocated to a different client, a deployment request is received at hibernated image selector 120. The deployment request includes information necessary for selecting an appropriate hibernated image for copying onto an IT resource. For example, the deployment request may include device specifications of the IT resource, such as processor type and available memory. The deployment request may also include information such as a requested operating system. In one embodiment, the hibernated image is selected based at least in part on device specifications of the IT resource.

Hibernated image selector 120 is operable to select a hibernated image from hibernated image library 110 and to copy that image onto a boot disk of the IT resource. In one embodiment, the boot disk of the IT resource is scrubbed prior to copying the hibernated image onto the boot disk. Once the hibernated image is copied onto the IT resource, the IT resource may be awakened from the hibernated state into a fully operational state. In one embodiment, hibernated image selector 120 is operable to determine whether the selected hibernated image is already copied onto the computer system. If the hibernated image is already copied onto the computer system (e.g., the computer system was never reallocated), the hibernated image is not copied onto the computer system. As described above, awakening a computer system from a hibernated state is typically much faster than booting the computer system from scratch.

Data centers frequently use one or more utility computing environments to manage resources. According to one embodiment, a rapid server deployment system can be used in the context of a utility computing environment for rapidly deploying IT resources using a hibernated image.

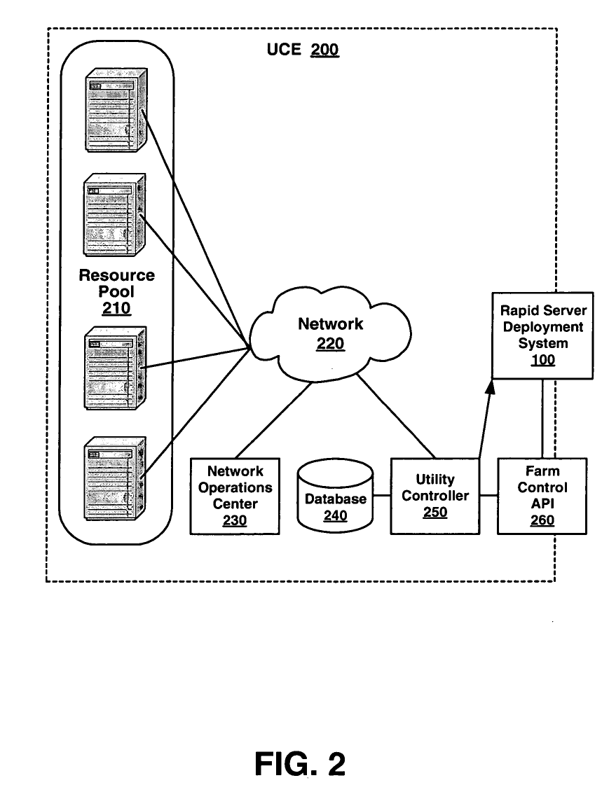

FIG. 2 is a block diagram of an exemplary software system including a rapid server deployment system, in accordance with embodiments of the present invention. The blocks that represent features in FIG. 2 can be arranged differently than as illustrated, and can implement additional or fewer features than what are described herein. Moreover, the blocks of FIG. 2 may be distributed across a utility data center (e.g., utility data center 400 of FIG. 4) or a network, such as a local area network (LAN). Further, the features represented by the blocks in FIG. 2 can be combined in various ways.

As depicted in FIG. 2, the exemplary software system includes a utility computing environment (UCE) 200, a rapid server deployment system 100, and a farm control application program interface 260 (API) that is also on the edge of the UCE 200. The UCE 200 also includes a pool of resources 210, a network operations center 230 (NOC), a database 240, a utility controller 250 (UC) and a network 220. The network 220 couples the resources 210, the NOC 230 and the UC 250 together. The database 240 and the UC 250 can communicate, the UC 250 can communicate with rapid server deployment system 100 and the Farm Control API 260. The rapid server deployment system 100 and the farm control API 260 can communicate with each other.

The resources 210 can be computational servers, firewalls, load balancers, data backup devices, and arrays of data storage disks, among other things. A “farm” can be created from one or more of the resources 210, as will be explained in more detail. One or more of computational devices can be automatically deployed from the pool of resources 210 to create a farm. The resources 210 associated with a farm are typically networked together using a network map, as will become more evident. The database 240 is machine-readable and contains information describing the resources 210 and the attributes of the resources 210 that are associated with “farms,” according to one embodiment. The UC 250 is a system that uses a network map as a specification to create “farms” by automatically configuring and deploying resources from the pool of resources 210, according to one embodiment. One or more data center administrators (DCAs), for example, can use the NOC 230 to operate the UCE 200. The DCAs can use a portal (not shown) to submit requests to the UC 250 or to update information associated with the database 240.

The farm control API 260 allows external computer programs (not shown) to perform operations on the farms. The rapid server deployment system 100 is capable of making decisions to automatically reallocate the resources 210 to by copying hibernated images onto the resources, according to one embodiment.

The exemplary software system also includes a library of backup media (not shown) and a user interface (not shown) that allows a DCA to update designs of farms with attributes, according to one embodiment. Examples of the attributes are the criticality of an application and a minimum quantity of resources 210 that an application needs in order to execute. The designs of the farms can be stored in the database 240. The library of backup media can contain regularly updated applications and data from remote UCEs 200. The remote UCEs 200 can use an external network 270 to communicate with the rapid server deployment system 100.

### RESOURCES

The resources 210 can be any component that is hardware, software, firmware, or combination thereof that can be used by a data center to provide services. For example, the resources 210 can be computational servers, firewalls, load balancers, data backup devices, arrays of data storage disks and network interface cards (NICs), among other things.

### FARMS AND FARM DESIGNS

A “farm” can be created from one or more of the resources 210. For example, one or more computational servers can be automatically deployed from the pool of resources 210 associated with a UCE 200 to create a farm. The resources 210 associated with a farm are typically networked together using a network map.

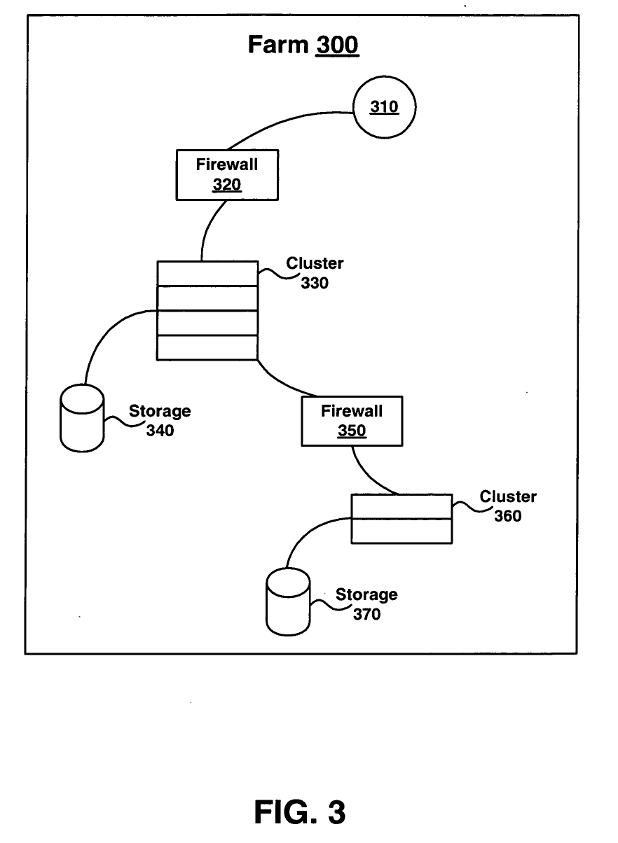

FIG. 3 is a block diagram of an exemplary farm, according to embodiment of the present invention. The blocks in FIG. 3 can be arranged differently than as illustrated, and can implement additional or fewer features than what are described herein. Further, the features represented by the blocks in FIG. 3 can be combined in various ways.

As depicted in FIG. 3, the farm 300 includes various resources, such as a backbone 310, two firewalls 320, 350, two clusters of servers 330, 360, and two storage devices 340, 370. Applications can be installed and executed on the clusters of servers 330, 360. Data that the applications create and/or use can be stored on the storage devices 340, 360. The firewalls 320, 350 can be used for protecting the applications on clusters 330, 360 and the data on storage devices 340, 370. The backbone 310 allows the farm 300 to communicate with the rest of the resources associated with a data center.

A farm design can be depicted with a schematic, such as that depicted in FIG. 3. A farm design depicts what resources 310, 320, 330, 340, 350, 360, 370 are associated with the farm 300 and how the resources 310, 320, 330, 340, 350, 360, 370 are connected, among other things

### DATA CENTER

FIG. 4 is a block diagram of an exemplary utility data center, according to embodiments of the present invention. A data center, also known as a utility data center (UDC) 400 is shown bounded by a virtual security boundary 450. Boundary 450 is shown here only to help illuminate the concepts presented herein. Typical UDC 400 comprises an operations center local area network (LAN) 405, a data center UC LAN 401 and resource pools 406. According to one embodiment, resource pools 406 are an example of resource pool 210. It is noted here that, by their very nature, UDCs are flexible in their composition, comprising any number and type of devices and systems. It is this flexibility from which they derive their usefulness. The specific architecture illustrated in FIG. 4, therefore, is not meant to limit the application of embodiments of the present invention to any particular provisionable network architecture.

Typical UDC 400, in this illustration, communicates with the outside world via the Internet 420 and virtual public networks (VPNs) in the Internet. The communications links that enable this communication are protected by firewall 410. Firewall 410 is shown to illustrate a concept and is not meant to imply any particular method or system of intrusion protection. Many types of hardware and software firewalls are well known in the art and firewall 410 may be either or both.

It is noted here that communications into and out of a provisionable network, as in any network, is accomplished through ports such as illustrated at 481. Communications between devices within a network are also conducted through ports, as alluded to at 482. It is noted that ports are not necessarily physically located at the periphery of a network but are logical end points. External ports 481 and intra-network ports 482 are shown only to help illustrate the concepts presented in embodiments of the present invention. It is also noted that virtual security boundary 450 does not exist in a physical sense. Resources included in the servers and LANs comprising utility data center 400 may include devices and servers located remotely from the other elements of the UDC.

Embodiments of the present invention operate in an environment that distinguishes between three trust domains established in the trust hierarchy of a utility data center. One trust domain is embodied in the Operations Center (OC) LAN 405 where non-critical UDC and other operations-related functions reside. The level of trust is less than the Data Center Control LAN 401. Another trust domain is the data center controller LAN 401 where tasks relating to the automated provisioning of managed resources 406 reside. Access to the Data Center LAN 401 is severely restricted from this domain. A third domain comprises the managed resources LANs where the managed resources 406 reside. These LANs are typically not trusted. It is noted here that clients of the utility data center originate outside the above trust structure and access elements of the UDC via the Internet or a virtual private network (VPN) resident in the Internet infrastructure.

As shown in FIG. 4, operations center (OC) LAN 405 comprises an internal trust domain. Included in OC LAN 405 are manager-of-managers (MoM) server 409, network intrusion detection system (NIDS) 412 and NIDS manager 411. It is noted that, though NIDS 412, NIDS manager 411 are illustrated as computer-like devices, their physical existence is not limited to a particular device. Each may exist as a standalone device or implemented as software resident in a physical device or server.

The heart of the exemplary utility data center illustrated in FIG. 4 is the data center utility controller LAN, 401. This LAN represents another, higher, internal trust domain. UC LAN communicates through OC LAN 405 and is typically separated from it by various forms of firewalls 402. UC LAN 401 can comprise various numbers of resource managers, such as illustrated at 403. The flexibility inherent in the UDC concept can result in many combinations of resources and resource managers. Resource managers 403 are the typical interface with the various pools of resources 406, communicating with them through ports and some sort of switching network as indicated by the tier 1 switch at 408.

Resource pools 406 are limitlessly flexible, comprising any conceivable combination of provisionable resources, such as resource servers, data servers, computational capability, load balancing servers or any other device or capability imaginable. Because the possible varieties of resources that can be included in resource pools 406, they are separated from UC LAN 401 by firewalls 404, which, like UC firewalls 402, can be software or hardware or both, in many combinations.

### OPERATIONAL EXAMPLE

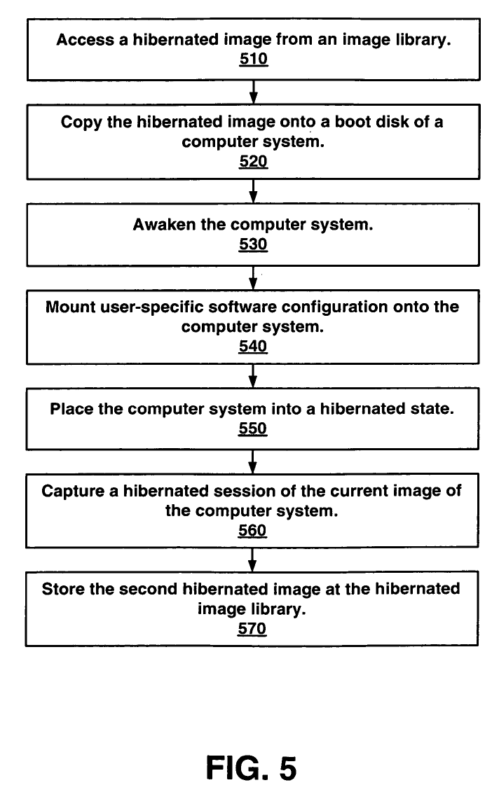

FIG. 5 depicts a process 500 for a method for rapid startup of a computer system, in accordance with embodiments of the present invention. Although specific steps are disclosed in process 500, such steps are exemplary. That is, embodiments of the present invention are well suited to performing various other steps or variations of the steps recited in process 500. It is appreciated that the steps in process 500 may be performed in an order different than presented, and that not all of the steps in process 500 may be performed. All of, or a portion of, the embodiments described by process 500 can be implemented using computer-readable and computer- executable instructions which reside, for example, in computer-usable media of a computer system or like device. In one embodiment, process 500 is executed by rapid server deployment system 100 of FIG. 1.

As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

At step 510 of process 500, a hibernated image from an image library is accessed. The image library (e.g., hibernated image library 110 of FIG. 1) includes a plurality of hibernated images. A hibernated image includes information captured by an operating system when a running computer system is placed into a hibernated state such that a hibernated computer system is operable to awaken from a hibernated state faster than booting a powered down computer system. It should be appreciated that the information included in a hibernated image may vary across different operating systems. Specifically, the information included in the hibernated image allows for a computer system running a particular operating system to awaken from a hibernated state.

In one embodiment, the computer system is a provisionable resource or IT resource in a utility computing environment. For example, the computer system may be a resource of resources 210 of FIG. 2. In a utility computing environment, a pool of servers are available for allocation to requesting clients. In one embodiment, the hibernated image is accessed in response to a deployment request received at an operations center (e.g., NEC 230 of FIG. 2) of a utility computing environment.

In one embodiment, the hibernated image is selected from the plurality of hibernated images based at least in part on device specifications of the computer system. For example, the image library may include hibernated images for various types of processors, operating systems, and memory requirements. The accessed hibernated image is selected to most closely match the device specifications of the allocated resource. For example, in a computer system operating a particular type of processor, a hibernated image would be accessed that was created on a computer system operating the same type of processor. Additionally, in a computer system that is designed to execute a particular operating system, a hibernated image created on a computer system running the same operating system will be selected.

At step 520, the hibernated image is copied onto a boot disk of the computer system. In one embodiment, the boot disk is scrubbed prior to the hibernated image being copied onto the boot disk. In one embodiment, before the hibernated image is copied onto the boot disk, it is determined whether the selected hibernated image is already copied onto the boot. If the hibernated image is already copied onto the computer system (e.g., the computer system was never reallocated), the hibernated image is not copied onto the computer system, and step 520 may be skipped.

At step 530, the computer system is awakened from the hibernated state. Awakening the computer system operates to provision the server to a particular client. As described above, awakening a computer system from a hibernated state occurs more rapidly than rebooting the same computer system from scratch. Depending on the configuration of the computer system, the time required to provision the computer system can be reduced from up to an hour down to a few minutes or even seconds.

At optional step 540, a user-specific software configuration is mounted onto the computer system. Once the computer system is awakened, and thus provisioned, additional operations may occur for customizing the computer system. For instance, specific user preferences are software applications may be identified and mounted onto the computer system. In one embodiment, the customized features are described in the deployment request.

Various embodiments of the present invention also provide for creating and storing hibernated images of a current session of a computer system. For example, a provisionable resource may be reallocated at the end of a particular user's shift. Prior to reallocation, a hibernated image of the current session may be captured so that the user may continue their work at the beginning of their next shift.

At step 550, the computer system is placed into a hibernated state. At the time of the hibernation, the computer system is operating a current session, which refers to the session open to the user. At step 560, a hibernated session of a current image of the computer system is captured. To distinguish from the hibernated image accessed at step 510, the hibernated image of the current session is referred to as a second hibernated image. At step 570, the second hibernated image is stored at the image library. It should be appreciated that steps 550 through 570 are optional. Moreover, it should be appreciated that the process described in steps 550 through 570 may be used to create any type of hibernated image, and is not restricted to creating a hibernated image of a current session. For instance, an administrator can create a number of hibernated images customized to various degrees. These hibernated images can then be stored in the image library for later access.

In summary, in its various embodiments, the present invention provides for rapid startup of a computer system. In particular, various embodiments provide for rapid deployment of resources in a utility computing environment by using hibernated images. By copying a hibernated image onto a provisionable resource, high-speed delivery of the resource can be delivered to a client. Awakening a computer system from a hibernated state occurs much faster than a complete restart of the computer system from scratch. In many cases, the delivery time of the resource to the client can be reduced from up to an hour down to a matter of minutes or seconds. Accordingly, the described invention provides for higher performance for deploying resources in a utility computing environment, as the deployment time may be reduced to several minutes.

It should be appreciated that embodiments of the present invention are directed towards using a hibernated image to activate computer systems other than the one it was captured from. By providing a hibernated image that is fungible to other computer systems besides the originating computer system, additional functionality is provided. In addition to the rapid deployment of provisionable resources in a utility computing environment, as described above, the present invention also supports rapid failover replacement of a failed computer system and rapid cloning of a server type for taking on higher load. Each computer system activated from a generic hibernated image will still activate with its own its own identity, e.g., via network resolution and system name resolution from an associated file system.

Various embodiments of the present invention, a method for rapid startup of a computer system, are described herein. While the present invention has been described in particular embodiments, it should be appreciated that the present invention should not be construed as limited by such embodiments, but rather construed according to the following claims.

What is claimed is:

1. A method for rapid startup of a computer system, said method comprising:
accessing a hibernated image from an image library comprising a plurality of hibernated images, said hibernated image comprising information captured by an operating system when a running computer system is placed into a hibernated state wherein a hibernated computer system is operable to awaken from a hibernated state faster than booting a powered down computer system;
copying said hibernated image onto a boot disk of said computer system; and
awakening said computer system from said hibernated state.

2. The method as recited in claim 1 further comprising mounting a user-specific software configuration onto said computer system.

3. The method as recited in claim 1 further comprising placing said computer system into a hibernated state; and
capturing a hibernated image of a current session of said computer system in a second hibernated image.

4. The method as recited in claim 3 further comprising storing said second hibernated image at said image library.

5. The method as recited in claim 1 wherein said computer system is a server of a utility computing environment.

6. The method as recited in claim 1 wherein said accessing said hibernated image comprises selecting said hibernated image from said plurality of hibernated images based at least in part on device specifications of said computer system.

7. A method for rapid provisionable resource deployment in a utility computing environment, said method comprising:
accessing a hibernated image from an image library comprising a plurality of hibernated images, said hibernated image comprising information captured by an operating system when a running computer system is placed into a hibernated state wherein a hibernated computer system is operable to awaken from a hibernated state faster than booting up a powered down computer system;
copying said hibernated image onto a boot disk of a provisionable resource of said utility computing environment, wherein said utility computing environment comprises a plurality of provisionable resources; and
awakening said provisionable resource from said hibernated state.

8. The method as recited in claim 7 further comprising mounting a user-specific software configuration onto said provisionable resource.

9. The method as recited in claim 7 further comprising:
placing said provisionable resource into a hibernated state; and
capturing a hibernated image of a current session of said provisionable resource in a second hibernated image.

10. The method as recited in claim 9 further comprising storing said second hibernated image at said image library.

11. The method as recited in claim 7 wherein said plurality of provisionable resources comprises a plurality of servers.

12. The method as recited in claim 7 wherein said accessing said hibernated image comprises selecting said hibernated image from said plurality of hibernated images based at least in part on device specifications of said provisionable resource.

13. A computer-usable medium having computer-readable program code embodied therein for causing a computer system to perform a method for rapid provisionable resource deployment in a utility computing environment, said method comprising:
accessing a hibernated image from an image library comprising a plurality of hibernated images, said hibernated image comprising information captured by an operating system when a running computer system is placed into a hibernated state wherein a hibernated computer system is operable to awaken from a hibernated state faster than booting up a powered down computer system;
copying said hibernated image onto a boot disk of a provisionable resource of said utility computing environment, wherein said utility computing environment comprises a plurality of provisionable resources; and
awakening said provisionable resource from said hibernated state.

14. The computer-usable medium as recited in claim 13 wherein said method further comprises mounting a user-specific software configuration onto said provisionable resource.

15. The computer-usable medium as recited in claim 13 wherein said method further comprises:
placing said provisionable resource into a hibernated state; and
capturing a hibernated image of a current session of said provisionable resource in a second hibernated image.

16. The computer-usable medium as recited in claim 15 wherein said method further comprises storing said second hibernated image at said image library.

17. The computer-usable medium as recited in claim 13 wherein said plurality of provisionable resources comprises a plurality of servers.

18. The computer-usable medium as recited in claim 13 wherein said accessing said hibernated image comprises selecting said hibernated image from said plurality of hibernated images based at least in part on device specifications of said provisionable resource.

19. A data center comprising:
a plurality of information technology resources and connections coupled with said plurality of information technology resources, wherein said plurality of information technology resources are represented in a computer-readable map;
an image library comprising a plurality of hibernated images, a hibernated image comprising information captured by an operating system when a running computer system is placed into a hibernated state wherein a hibernated computer system is operable to awaken from a hibernated state faster than booting up a powered down computer system; and
a hibernated image selector for selecting a hibernated image from said image library and for copying said hibernated image onto a boot disk of an information technology resource of said plurality of information technology resources, wherein said information technology resource is operable to be awakened from said hibernated state of said hibernated image.

20. The data center as recited in claim 19 wherein said hibernated image selector is operable to select said hibernated image from said plurality of hibernated images based at least in part on device specifications of said information technology resource.
